(19) United States
(12) Patent Application Publication
(10) Pub. No.: US 2008/0019689 A1
(43) Pub. Date: Jan. 24, 2008

(54) Method For Remote Access Of An Optical Network Device In A Passive Optical Network

(76) Inventors: Dana Brooks, Heathrow, FL (US); Andrew M. Scott, Lake Mary, FL (US); Kiet V. Truong, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/579,425

(22) PCT Filed: Mar. 9, 2005
(86) PCT No.: PCT/EP05/51042

§ 371 Date: Nov. 2, 2006

Related U.S. Application Data
(60) Provisional application No. 60/570,573, filed on May 13, 2004.

(51) Int. Cl. H04B 10/08

(52) U.S. Cl. 398/17

(57) ABSTRACT

The claimed invention provides a method of a remotely accessing a decentralized device in a conventional fiber to the premises network via a centralized display device operatively connected to an optical line terminal. The invention further provides the decentralized device adapted to be remotely accessed by the display device. The invention further provides a debug managed entity instance.

### CROSS-REFERENCE TO RELATED APPLICATIONS

The present application claims the benefit of the provisional patent application filed on May 13, 2004, and assigned application No. 60/570,573.

### FIELD OF THE INVENTION

The invention relates generally to remote access of network devices, and specifically to the access of remote passive optical network devices.

### BACKGROUND OF THE INVENTION

The use of fiber optic cables to carry information signals continues to grow in popularity worldwide. Digital information signals modulate light traveling on the fiber optic cable between a source node and a receiving node. As is well known, fiber optic cable has a much higher information carrying capacity than copper wire, including the ubiquitous unshielded twisted copper pair commonly used for providing dial-up telephone service. As fiber continues to be deployed throughout telecommunications networks, its advantages over copper accrue to the user. Generally, fiber exhibits a higher bandwidth and lower signal losses than copper conductors. Fiber is also more reliable and has a longer useful life than copper conductors. Since fiber does not emit any electromagnetic radiation, it is a more secure transmission medium than copper.

A passive optical network (PON), including for example a B-PON (broadband passive optical network) or a G-PON (gigabit passive optical network), provides multiple data transmission paths each capable of delivering high-bandwidth data services to multiple subscribers. An exemplary B-PON comprises 32 or extensible to 64 such data paths, each data path comprising one fiber optic cable. A G-PON comprises, for example, 64 or 128 data paths. A standardized PON protocol controls and manages the transmission and reception of signals across the passive optical network.

In addition to the fiber optic cable, the PON optical distribution network (ODN) further comprises optical splitters and combiners for directing information signals propagating between an optical line terminal (OLT), which is a centralized device, and a plurality of optical network devices (OND) that are decentralized.

According to current standards, the fiber optic path on a PON network operates at data rates of 155 Mbps, 622 Mbps, 1.25 Gbps, and 2.5 Gbps. Bandwidth allocated to each customer from this aggregate bandwidth can be statically or dynamically assigned to support voice, data, video and multimedia applications.

The conventional PON topology comprises a shared upstream signal path and a broadcast downstream path. Downstream data, including an address header, is broadcast from the OLT to all OND's. Each OND identifies the data intended for it, using an address matching process.

Use of a broadcast mechanism for upstream traffic requires a scheme to avoid data collisions. One technique for managing the upstream traffic employs a TDMA (time division, multiple access) protocol in which dedicated transmission time slots are granted to each OND. All OND's are time synchronized and each transmits data only during its assigned time slot. Upstream data received by the OLT from an OND is processed and forwarded to its intended destination beyond the PON.

Typically, transmitters employed in fiber optic communication systems emit light at one of three wavelengths: 1310 nanometers, 1490 nanometers and 1550 nanometers, where the specified wavelength is approximately at the center of the signal bandwidth. Signals at these wavelengths experience relatively low attenuation as they propagate through the fiber and therefore represent good choices for fiber optic communications.

A network architecture reference model for the B-PON is described in the International Telecommunications Union (ITU) Specification ITU-T G.983.1, entitled, Broadband Optical Access Systems Based on Passive Optical Networks (PON), which is incorporated herein by reference. Additional information can be found in related ITU specifications G.983.x, which are incorporated by reference. G-PON reference models are described in the International Telecommunications Union Specifications ITU-T G.984.1 through 9844, which is also incorporated by reference.

A display unit which includes a monitor and an input device such as a keyboard or mouse can be attached to the OND through a serial port on the OND allowing a user to run commands that are available via a serial interface of the OND. The commands may be but are not limited to diagnostics and debugging. This implementation requires that the user travel to the location of the OND and transport the display unit. This could be time consuming and costly especially if the user needs to run commands on more than one OND. Additionally, the OND may be situated such that it would be difficult or dangerous for the user to hook up and use the display unit. Therefore, there exists a need to provide a cheaper and more convenient means to access a decentralized device within a PON.

### BRIEF SUMMARY OF THE INVENTION

The present invention provides for a method for remotely accessing an decentralized device operatively connected to an optical line terminal via a passive optical network, comprising receiving from the network an optical network terminal management and control interface debug command request message comprising a message identifier indicating a debug managed entity instance, a debug command data containing at least part of a user command, and a more command indicator indicating if more optical network terminal management and control interface debug command request messages are to be sent. The method further comprising extracting the debug command from the request message, sending an optical network terminal management and control interface debug command response message to the network and if the more command indicator indicates that all the messages have been sent executing the debug command data in the decentralized device, capturing an output generated by the executed command into a first buffer.

The present invention provides an optical network device in a passive optical network adapted to he remotely accessed, comprising a single debug managed instance, a generic management software unit for managing the debug managed entity instance, a command software unit that can be remotely accessed via a serial port management system software unit, and a remote command processing software unit operatively connected to the generic management software unit and the serial port management system; the remote command processing unit converting data from the debug managed instance entity to a serial port management system software unit acceptable format and converting data from the serial port management system software unit to the debug managed instance entity acceptable format.

A debug managed entity instance existing within an optical network device in a passive optical network, comprising a first action to provide a user input and a second action to provide results generated from the user input and a managed entity identifier representing the instance of the debug managed entity.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a conventional fiber to the premises network.

FIG. 2 illustrates a preferred embodiment of an optical network device in accordance to the invention.

FIG. 3 illustrates a flowchart representative of an exemplary embodiment of a method in accordance with the invention.

FIG. 4 illustrates an exemplary message flow between an optical network device and an optical line terminal in accordance to the invention.

### DETAILED DESCRIPTION OF THE INVENTION

Before describing in detail a particular method and apparatus for remote access of decentralized devices according to the present invention, it should he observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

In the forgoing and following description the term “subscriber” pertains to a client of the network such as but not limited to a individual accessing the network at a home or business. The term “user” pertains to a person or machine acquiring access to the OND via a display unit.

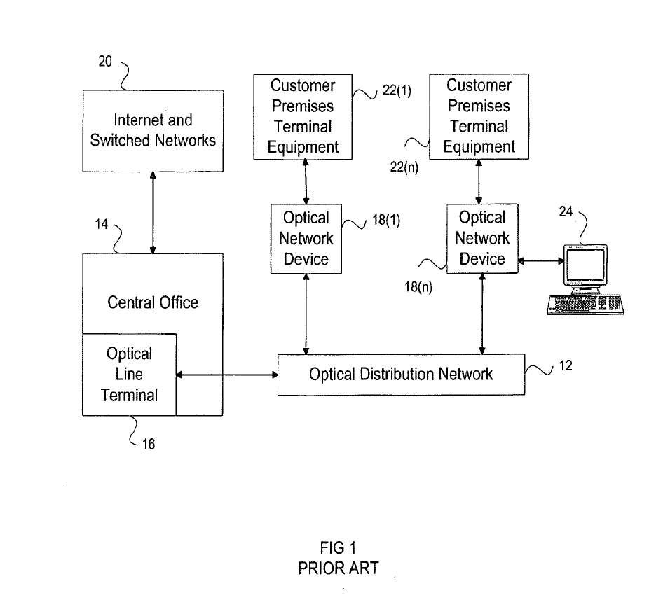

FIG. 1 illustrates a conventional fiber to the premises (FTTP) network 10 comprising an optical distribution network (ODN) 12 (also referred to or having the attributes of a passive optical network (PON), a broadband passive optical network (B-PON) or a gigabit passive optical network (G-PON)) providing an optical communications link between a central office 14 of a telecommunications provider and subscribers. As described below, the optical distribution network 12 may provide various types of service, e.g., FTTH (fiber to the home), FTTBusiness (fiber to the business), FTTB/C (fiber to the building/curb) and FTTCab (fiber to the cabinet).

According to one embodiment of the FTTP network 10, information signals are carried over the network at wavelengths of 1310 nm, 1490 nm and 1550 nm. The 1310 nm signal is used for upstream traffic and the 1490 and 1550 signals for downstream traffic. Multimedia and video signals are carried at 1490 nm, while data and telephone service is provided on 1550 nm.

Voice, data, video and multimedia broadband services may be supplied from an Internet and switched networks 20 connected to the central office 14 for distribution to subscribers through the PON or ODN 12. The Internet and switched networks 20 are representative of various networks capable of sending information to and receiving information from the subscribers. These networks, which are commonly known to those skilled in the art, include: video and multimedia networks, TDM/PTN networks, ATM networks, and IP networks. Thus, at the subscriber's site, the FTTP network 10 provides multiple information services including: video and multimedia signal delivery, telephone service and Internet access.

Service is provided to one or more subscribers' customer premises terminal equipment (CPTE) 22 via an optical network device (OND) 18. The CPTE 22 may be connected directly to the OND 18 or operatively connected via another device (not shown) such as a modem. The OND 18 may be but is not limited to an optical network unit (ONU) or optical network terminal (ONT). Typically an ONT is powered externally whereas an ONU has its own power source. Additionally, the OND 18 may be a single-subscriber optical network unit providing a single subscriber with access to the ODN 12 or a multiple distribution network (MDU) providing a plurality of subscribers access to the network.

The central office 14 comprises an optical line terminal (OLT) 16 operative as a optical transceiver for broadcasting data, multimedia and telephone signals to the OND 18 and for receiving data, multimedia and telephone signals from the OND 18 that originated from a CPTE 22. The OLT 16 also operates as a network manager for managing the OND 18 executing its network management functions in accordance with an ONT management and control interface (OMCI).

FIG. 1 illustrates a decentralized display unit 24 that includes a monitor and an input device such as a keyboard or mouse can be attached to the OND 18 through a serial port on the OND 18 allowing a user to run commands that are available via a serial interface of the OND 18. The commands may include hut are not limited to diagnostics and debugging commands. Methods consistent with the present invention make it possible to remotely access the OND 18 without using such a display unit 24.

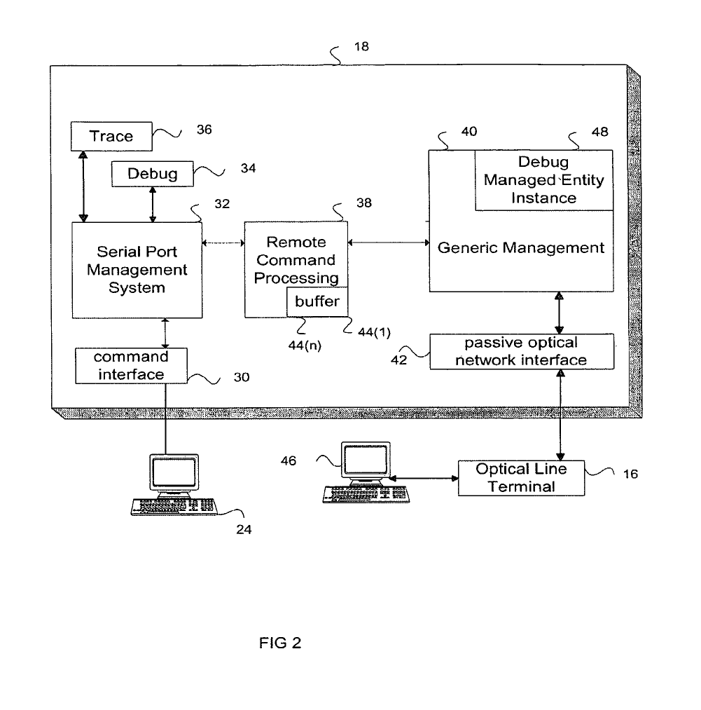

The following is an overview of a typical embodiment of the OND 18 as illustrated by FIG. 2. A centralized display unit 46 located at the OLT 16 allows a user to run a command that will be transmitted to the OND 18 via messages. The message descriptions are described in later text. The message containing the command is received by a generic management 40 that accesses a debug managed entity instance 48. The debug managed entity instance 48 handles retrieving the command from the message and providing the commands to a remote command processing software unit 36. The command is stored in a buffer 44 and a response message is generated to the OLT 16 by the debug managed entity 48 or the remote command processing software unit 38. Subsequent messages are received and responded to until all the user input has been received by the OND 18. The stored data is transferred from the remote command processing software unit 44 to a serial port management system (SPMS) software unit 32 that causes the command to be executed. The results of the execution are transferred back by the SPCS software unit to the remote command processing software unit 38 and stored in a buffer 44. The remote command processing unit 38 or the debug managed entity instance 48 notifies the OLT 16 via a message that the command has been executed. The OLT 16 sends a response message and a message to retrieve the result data. The message is received by a generic management 40 that accesses the debug managed entity instance 48. The debug managed entity instance 48 or the remote command processing software unit 38 handles retrieving the results from the buffer and sends a message containing this information to the OLT 16. Subsequent messages are received and responded to until all the response data has been sent by the OND 18.

FIG. 2 also illustrates an exemplary embodiment of the OND 18 consistent with an exemplary embodiment of the invention. The OND 18 which is a decentralized device located at or proximately at a subscriber's site. The OND 18 comprises a plurality of software units 32, 34, 36, 38, 40. The software units 32, 34, 36, 38, 40 comprise software code and may be organized as a function, a module, a method, or an executable process. A different organization of the software code from that illustration is acceptable and would not depart from the invention. Accessing the software units 32, 34, 36, 38, 40 may be achieved via a call to the function, module, method or process, via a message or a semaphore. However, access is not limited to these methods as those in skilled in the art would realize that there are other ways to access software code. FIG. 2 illustrates a preferred embodiment of the software units. However, new units may be added or illustrated units may be combined in anyway to create more or less units without departing from the invention. Also acceptable, the OND 18 may comprise a single software unit.

The OND 18 may further comprise a command interface 30 and the SPMS software unit 32. Commands entered by the user at the decentralized display unit 24 are received via a serial port by a command interface 30. A user interface such as a graphical user interface (GUI) or command line user interface is provided by the SPMS software unit 32. The user interface defines the valid user commands. Signals received by the command interface 30 are converted to a format that the SPMS software unit 32 accepts and sent to the SPMS software unit 32 that is operatively connected to the command interface 30. Methods consistent with the present invention make it possible to remotely access the OND 18 without using such a command interface 30.

Various command software units may be included such as 34, 36. A command software unit is a software unit providing the software to support the commands given by the user interface. FIG. 2 illustrates a debug software unit 34 and a trace software unit 36. This is not an exhaustive list of command software units but a representative list of typical command software units. A typical debug software unit 34 allows parameters of the OND 18 to be modified. A typical trace software unit 36 provides display of data during the operation of the OND 18.

After the SPMS software unit 32 receives the data, it is validated to ensure that it is a supported command. The SPMS software unit 32 accesses the corresponding command software unit 34, 36. The result from the command software unit 34, 36 is provided to the decentralized display unit 24 via the SPMS software unit 32 and command interface 30. The command software units 34, 36 could check for data validity as an alternative to having the SPMS software unit 32 validate the user input.

The OND 18 further comprises a generic management software unit 40, a plurality of managed entities and in accordance to the invention a debug managed entity instance 48. The debug managed entity instance 48 comprises, an attribute, actions and a notification.

In a preferred embodiment of the invention there is a single debug managed entity instance 48. However, multiple debug managed entity instances 48 may exist without departing from the invention. Typically the managed entity instance 48 is created after the initialization of the ONTD 18.

An identifier provides a unique identification for each managed entity instance 48. In a preferred embodiment of the invention the identifier is represented by a two byte hex value, 0×0000, representing a single debug managed entity instance 48. Those skilled in the art recognize that if multiple instances exist that each instance would require a unique identifier. Although a two-byte value is preferred any size value that would achieve unique identification of the entities would be acceptable.

Actions of the debug managed entity instance 48 describe what the debug managed entity instance 48 provides and or what is provided to the debug managed entity instance 48. It is preferable that the debug managed entity instance 48 have a debugCommand and a debugRetrieveResults actions. The debugCommand action provides user input to the debug managed entity instance 48. The debugRetrieveResults provides results generated from the user input were previously provided by the debugCommand. However, these actions could be combined or further actions provided without departing from the invention.

Notifications provide the ability for the OND 18 to send an asynchronous message based on an event. In a preferred embodiment of the invention a DebugResult notification is provided. This notification causes a message to be sent to the network when the results of the debugCommand arc ready to be received. Furthermore, in a preferred embodiment the DebugResult notification provides a status of the results such as an error occurred or no data was produced. However, as one skilled in the art will appreciate, the DebugResult notification does not have to be provided and that the debugRetrieveResults could be preformed without notification. Additionally, other notifications could be added without departing from the invention.

The OND 18 further comprises a passive optical network (PON) interface 42 for receiving and sending data to and from the OLT 16.

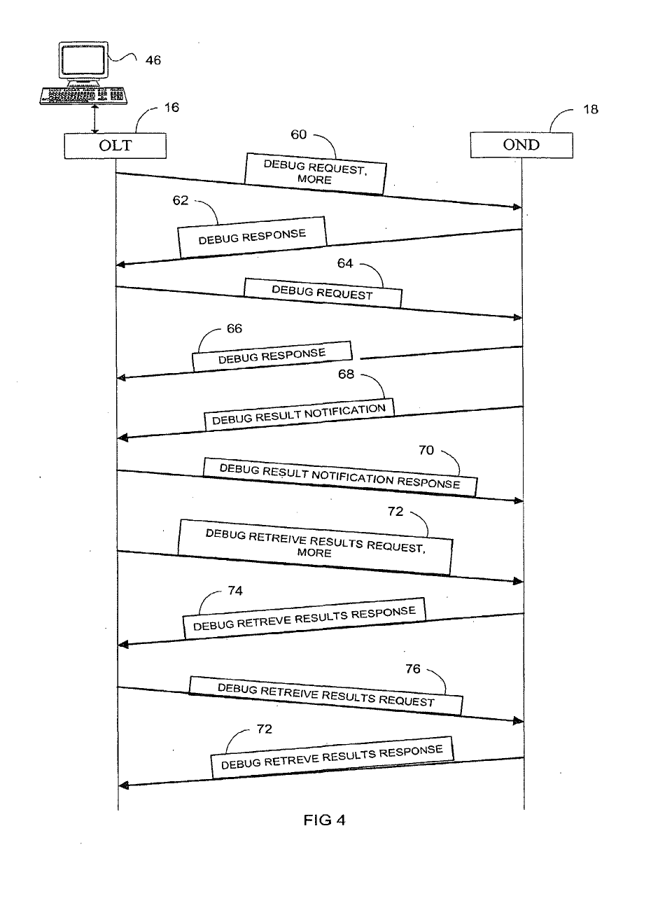

In accordance to the invention a centralized display unit 46 may be operatively connected to the OLT 16. Commands that a user enters are encapsulated into an OMCI message and sent to the generic management software unit 40 via the PON interface 42. The OMCI messages are further described in a following description of FIG. 4. The generic management software unit 40 receives the OMCI messages and identifies that they pertain to the debug managed entity.

The OND 18 further comprises the remote command process software unit 38. The remote command process software unit 38 interfaces the generic management software unit 40 or the debug managed entity with the SPMS software unit 32 via the debugCommand and getDebugDataNext actions associated with the debug managed entity. The user input provided by the debugCommand is converted to a format accepted by the SPMS software unit 32 by the remote command processing software unit 38. Also, the data from the SPMS software unit 32 is converted by the remote command processing software unit 38 to a format accepted by the debug managed entity. Thus, the remote command processing software unit 38 emulates the command interface 30.

It is preferable that the SPMS software unit 32 keeps track of the interface, the command interface 30 or remote command processing software unit 38, where it received its command input . The SPMS should then only transfer the results from executing the command input to the interface that sent the command input.

The OND 18 further comprises a plurality of buffers 44(1) . . . 44(n) in order for the remote command processing software unit 38 to emulate the command interface 30. The buffers 44 can be any storage medium such as memory or a magnetic disk and must be operatively accessible by the remote command processing software unit 38. A single buffer 44 is also acceptable.

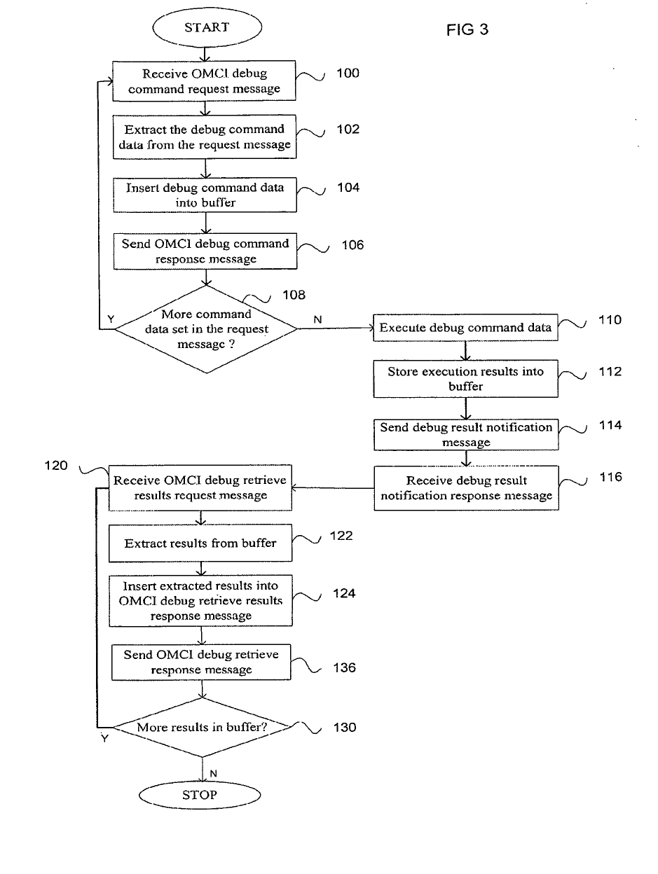

FIG. 3 illustrates an exemplary method for remotely accessing the OND 18 from the OND 18. Steps 100, 102, 104, 106 and 108 handle receiving user data. Command execution is handled by steps 111 and 112. Notification processing is described by steps 114 and 116. Result handling is described in steps 120, 122, 124, 126, and 130. Communication to the OND 18 from the OLT 16 and to the OLT 16 from the OND 18 is achieved via OMCI messages.

An OMCI debug command request message is received in step 100 by the OND 18. The OND 18 extracts the command data from the OMCI debug command request message 102 and inserts the extracted data in a buffer 104. The preferred embodiment of the command data is in ASCII; however, as will be appreciated by those skilled in the art, other suitable embodiments can be used. The OND 18 sends an OMCI debug command response message to the OLT 16 in step 106

Idealy the data extracted from the OMCI debug command message 102 comprises the entire command or commands entered by the user at a centralized display unit 46 operatively connected to the OLT 16. However, this may not be possible due to such factors as the message length or the size of the user data. Therefore a mechanism to indicate that the data will be sent in a plurality of messages must be provided. A preferred mechanism is to set a more indicator in the OMCI debug command request message 100 when the message does not complete the user command. This indicator is checked in step 108 by the OND 18. If the more indicator is set more message will be received to complete the command.

Once the command data has been retrieved the command or commands are executed 110 by the OND 18. The results of the execution are stored within a buffer 112. The buffer which can be any storage medium such as memory or a magnetic disk and must be operatively accessible by the OND 18.

In a preferred embodiment, the OND 18 includes the steps 114 and 116 to handle notification. The debug result notification message 114 sent by the OND 18 informs the OLT 16 that execution has taken place. The OND 16 receives the debug result notification response from the OLT 18. This mechanism is used to prevent the OMCI debug retrieve results request message 120 being sent to the OND 18 prior to the OND 18 being able to service the message. However, in another embodiment the notification mechanism 114 and 116 is not provided.

The OND 18 receives an OMCI debug retrieve results request message in step 120. The execution results are extracted from the buffer and inserted into an OMCI debug retrieve results response message 124 and an OMCI debug retrieve response message 136 is sent 136. Ideally the results extracted from the buffer 122 and inserted into OMCI debug command message 124 comprises the entire results. However, this may not be possible due to such factors as the message length or the size of the results. Consequently a mechanism to indicate that the data will be sent in a plurality of messages must be provided. A preferred mechanism is to set a more indicator in the OMCI debug retrieve response message 124 when the message does not complete the results 130. If the more indicator is set more messages will be received and sent to complete the command.

FIG. 4 illustrates an exemplary remote access message flow. The centralized display unit 46 is operatively connected to the OLT 16. Commands that the user enters at the centralized display unit 46 or that are generated by the OLT 16 are sent via an OMCI debug command request 60, 64 to the remote command processing software unit 38 within the OND 18. A preferred embodiment of the OMCI debug command request 60, 64 comprises a message identifier, a command data, and a more indicator. The message identifier identifies the debug class managed entity and the instance of the debug class to which the message pertains. This identifier would preferably be used for all messages within a debug message flow. The command data provides user command input comprising one or more commands entered by the user. A preferred embodiment of the user data is in ASCII. However, as will be appreciated by those skilled in the art, other suitable embodiments can be used. It is preferable that the entirety of the user command input be placed into a single message. However, this may not be possible due to such factors as the message length or the size of the user data. Consequently, a mechanism to indicate that the user command input is in multiple messages must be provided. The preferred mechanism is through the more indicator that indicates that more messages will follow with additional command input. Those skilled in the art will recognize that alternatives such as a last indicator, a different message action and mechanisms not mentioned herein could be used without departing from the invention.

In the example shown by FIG. 4, the user command input could not fit into a single message. A first OMCI debug command request 60 indicates that more messages will follow via the more indicator. If the user command input cannot fit into a single message the OND 18 must store the command data into the buffer 44. An OMCI debug command response 62, 66 preferably comprises a message identifier and a result field wherein the message identifier would match the value sent in the request The result field would provide success or failure information. Those skilled in the art recognize that parameters can be modified, added, and or deleted without departing from the invention.

In a preferred embodiment, the message sequence of the OMCI debug command request with more message indicated 60 and the OMCI debug command response 64 is repeated until the last OMCI debug command request 64 indicating the last of the user command data is sent. Upon receiving the last OMCI debug command request message 66, the remote command processing software unit 38 must reassemble the command data into the user command. This may involve retrieving data from the OMCI debug request message 64, the buffer 44 and combinations thereof. The remote command processing software unit 38 converts the user command to the SPMS software unit 32 formats and transfers the data to the SPMS software unit 32 wherein the command is executed.

Results from the SPMS software unit 32 are transferred to the remote command processing software unit 38 and are stored in the buffer 44.

In a preferred message flow, an OMCI debug result notification message 68 and an OMCI debug result notification result message 70 are included. The OMCI debug result notification message 68 informs the OLT 16 that the command or commands have been executed. The preferred embodiment of the OMCI debug result notification message 68 comprises the message identifier and a status. The status comprises information about the results such as if it was successful, and if the results produced data. Those skilled in the art realize that the status could he included in subsequent messages instead of the OMCI debug result notification message 68. The OLT 16 responds to the OND 18 with an OMCI debug result notification response message 70 comprising the message identifier. Although it is preferable to include the OMCI debug result notification message 68 and the OMCI debug result notification response message 70 those skilled in the state of the art realize that not including these messages in the message flow is acceptable.

An OMCI debug retrieve results message 72 comprising the message identifier is sent from the OLT 16 to the OND 18. The OND 18 responds with an OMCI debug retrieve results response message 74. In a preferred embodiment, the OMCI debug retrieve results response message comprises a message identifier, a debug result, and a more indicator. The debug result comprises the results of the user command input. The preferred embodiment of the debug result is in ASCII. However, as will be appreciated by those skilled in the art, other suitable embodiments can be used. It is desirable that the entirety of the results to be placed into a single message; however, this may not be possible due to such factors as the message length or the size of the debug result. Consequently, a mechanism to indicate that the user command input is in multiple messages must be provided. The preferred mechanism is through the more indicator that indicates that more messages will follow with additionally debug results. Those skilled in the art will recognize that alternatives such as a last indicator, a different message type and mechanisms not mentioned herein could be used without departing from the invention. If the debug results cannot fit into a single message, the buffer 44 holding the holding the results must be managed so the debug results provided in the messages comprise all of the data in the buffer 44 without repeating data in the buffer 44. This management is preferably in the OND 18 but could be handled by information passed in the OMCI debug retrieve result request 72 and the OMCI debug retrieve result response 74 In the example shown by FIG. 4, the debug result could not fit into a single message. A first OMCI debug retrieve result request 72 indicates that more messages will follow via the more indicator. The OND 18 receives the OMCI debug retrieve results response message 74 and response with an OMCI debug retrieve results response message 76. Additionally, the OND18 transfers the results to the centralized display unit 46.

I claim as my invention:

1. A method for remotely accessing an decentralized device operatively connected to an optical line terminal via a passive optical network, comprising:
receiving from the network an optical network terminal management and control interface debug command request message comprising a message identifier indicating a debug managed entity instance, a debug command data containing at least part of a user command, and a more command indicator indicating if more optical network terminal management and control interface debug command request messages are to be sent;
extracting the debug command from the request message;
sending an optical network terminal management and control interface debug command response message to the network; and
if the more command indicator indicates that all the messages have been sent executing the debug command data in the decentralized device, capturing an output generated by the executed command into a first buffer.

2. The method of claim 1 further comprises
sending an optical network terminal management and control interface debug result notification message; and
receiving an optical network terminal management and control interface debug result notification response message.

3. The method of claim 1 further comprises
receiving an optical network terminal management and control interface debug retrieve results request message;
extracting results from the first buffer;
inserting extracted results into an optical network terminal management and control interface debug retrieve results response message;
if the first buffer contains more data to be sent indicating in an optical network terminal management and control interface debug result notification response message that there is more data;
sending an optical network terminal management and control interface debug result notification response message.

4. The method of claim 1 wherein the debug command data in the OMCI debug request message is in ASCII.

5. The method of claim 1 wherein the extracted debug command is stored in a second buffer is until the entire user command is extracted and then transmitting the complete command to the serial port management system software unit.

6. The method of claim 5 wherein the debug command data to be executed is retrieved from the second buffer.

7. The method of claim 1 wherein the debug managed entity comprises a debug command action.

8. The method of claim 1 wherein the debug managed entity comprises a get debug data next action.

9. The method of claim 1 wherein the debug managed entity comprises a debug result notification.

10. The method of claim 1 wherein the output is inserted into the response message in ASCII.

11. An optical network device in a passive optical network adapted to be remotely accessed, comprising:
a single debug managed instance;
a generic management software unit for managing the debug managed entity instance;
a command software unit that can be remotely accessed via a serial port management system software unit; and
a remote command processing software unit operatively connected to the generic management software unit and the serial port management system; the remote command processing unit converting data from the debug managed instance entity to a serial port management system software unit acceptable format and convening data from the serial port management system software unit to the debug managed instance entity acceptable format.

12. The optical network device of claim 11 wherein a plurality of debug managed entity exists.

13. The optical network device of claim 11 wherein generic management software unit is adapted to receive an optical network terminal management and control interface debug command request message which identifies the debug managed entity instance.

14. The optical network device of claim 11 wherein the generic management software unit is adapted to receive an optical network terminal management and control interface debug command request message which identifies the debug managed entity instance.

15. The optical network device of claim 11 wherein the generic management software unit is adapted to send an optical network terminal management and control interface debug command response.

16. The optical network device of claim 11 wherein generic management software unit is adapted to send an optical network terminal management and control interface notification

17. A debug managed entity instance existing within an optical network device in a passive optical network, comprising:
a first action to provide a user input and a second action to provide results generated from the user input; and
a managed entity identifier representing the instance of the debug managed entity.

18. The debug managed entity of claim 15 further comprising a debug result notification.
